(19) United States
(12) Patent Application Publication
(10) Pub. No.: US 2008/0311854 A1
(43) Pub. Date: Dec. 18, 2008

(54) Radio communications system, mobile radio terminal and radio comunications method

(75) Inventors: Yoshiyuki Kubo, Hino-shi (JP); Shigeo Terabe, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/903,168

(22) Filed: Sep. 20, 2007

(30) Foreign Application Priority Data
Jun. 15, 2007 (JP) 2007-158863

(51) Int. Cl. H04B 17/00

(52) U.S. Cl. 455/67.11

(57) ABSTRACT

In sequence S3, a mobile station measures a transmission path quality. In sequence S4, the mobile station decodes resource blocks allocated by a base station and executes CRC decision based on CRC bits. In sequence S6, the base station selects a transmission format on the basis of CQI received from the mobile station and allocates the resource blocks. In sequence S7, the mobile station receives a result of the CRC decision. In sequence S8, the base station executes an allocation correcting process of obtaining a rate of success S in receiving the resource blocks on the basis of the result of the CRC decision, and reviewing and reselecting the transmission format selected in the allocating process of the sequence S6 on the basis of the rate of success S.

### CROSS-REFERENCE TO RELATED APPLICATIONS

This application is based upon and claims the benefit of priority from prior Japanese Patent Application No. 2007-158863, filed Jun. 15, 2007, the entire contents of which are incorporated herein by reference.

### BACKGROUND OF THE INVENTION

1. Field of the Invention

The present invention relates to a radio communications system adaptively controlling a modulation scheme and a coding scheme.

2. Description of the Related Art

Recently, development of a radio communications system employing AMC (Adaptive Modulation and Coding) has been advanced (refer to, for example, 3GPP (3rd Generation Partnership Project) TS 25.214 V5.11.0 (2005-06) 6A HS-DSCH-related procedures). In this radio communications system, a mobile station measures a radio transmission quality from a signal received from a base station and transmits a result of the measurement to the base station as CQI (Channel Quality Indicator).

On the basis of the CQI, the base station selects a transmission format suitable for the transmission to the mobile station, from a table called MCS (Modulation and Coding Set), and notifies the mobile station of the selected transmission format over the control channel as control information. On the other hand, the mobile station receives the transmission information over an individual information channel, in the transmission format of which the base station notifies the mobile station over the control channel as the control information.

One of examples of such a radio communications system is a system employing OFDM (Orthogonal Frequency Division Multiplexing) as its modulation scheme. In the OFDM system, the number of reference signals (for example, phase reference signals) used for the CQI measurement is smaller than the number of the signals used for the data transmission. For this reason, a result of the CQI measurement may not exactly reflect the channel characteristics and the adaptive control cannot be executed with high accuracy.

### BRIEF SUMMARY OF THE INVENTION

The present invention has been accomplished to solve the above-described problem. The object of the present invention is to provide a radio communications system, a mobile radio terminal and a radio communications method, capable of executing adaptive control with a high accuracy to select a transmission format which exactly reflects a channel characteristic.

To achieve this object, an aspect of the present invention is a radio communications system comprising a base station accommodated in a mobile communications network and a mobile station which establishes radio communications with the base station. The mobile station comprises a measuring unit which receives a radio signal transmitted from the base station and measures a transmission path quality, a decision unit which executes error decision of data received from the base station, and a transmitter which transmits information based on a measurement result of the measuring unit and information based on a decision result of the decision unit. The base station comprises a receiver which receives the information transmitted from the transmitter, and a determiner which determines a transmission format of the data to be transmitted to the mobile station, with reference to the information based on the measurement result of the measuring unit and the information based on the decision result of the decision unit.

As described above, the mobile station measures the transmission path quality, executes error decision of data received from the base station, and transmits information based on results of the measurement and error decision to the base station. The base station determines a transmission format of data which are to be transmitted to the mobile station, on the basis of the information received from the mobile station.

Therefore, the present invention can provide the radio communications system, the mobile radio terminal and the radio communications method, wherein as the transmission format according to the transmission path quality and the error decision result of the received data is selected, the adaptive control can be executed with a high accuracy to select the transmission format which exactly reflects the channel characteristic.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration describing allocation of signals to subcarriers in a radio communications system of the present invention;

FIG. 2 is a block diagram showing a configuration of a mobile station in the radio communications system according to the present invention;

FIG. 3 is a table of a transmission format used in the radio communications system of the present invention;

FIG. 4 is a block diagram showing a configuration of a base station in the radio communications system of the present invention;

FIG. 5 is an illustration showing sector structures formed by the base station;

FIG. 6 is a sequence diagram showing operations of a radio communications system according to a first embodiment of the present invention;

FIG. 7 is a flowchart showing an allocation and correction process executed in the sequence shown in FIG. 6;

FIG. 8 is a sequence diagram showing operations of a radio communications system according to a second embodiment of the present invention;

FIG. 9 is a flowchart showing an allocation and correction process executed in the sequence shown in FIG. 8;

FIG. 10 is a sequence diagram showing operations of a radio communications system according to a third embodiment of the present invention; and

FIG. 11 is a flowchart showing an allocation and correction process executed in the sequence shown in FIG. 10.

### DETAILED DESCRIPTION OF THE INVENTION

Embodiments of the present invention will be explained below with reference to the accompanying drawings.

In a radio communication system such as an OFDM system, allocating a plurality of frequency bands to mobile stations (mobile radio terminals), a transmission format of an individual information channel is determined on the basis of CQI measured by the mobile stations. The determination is executed on the mobile station side or the base station side. In the following descriptions, the determination is executed on the base station side.

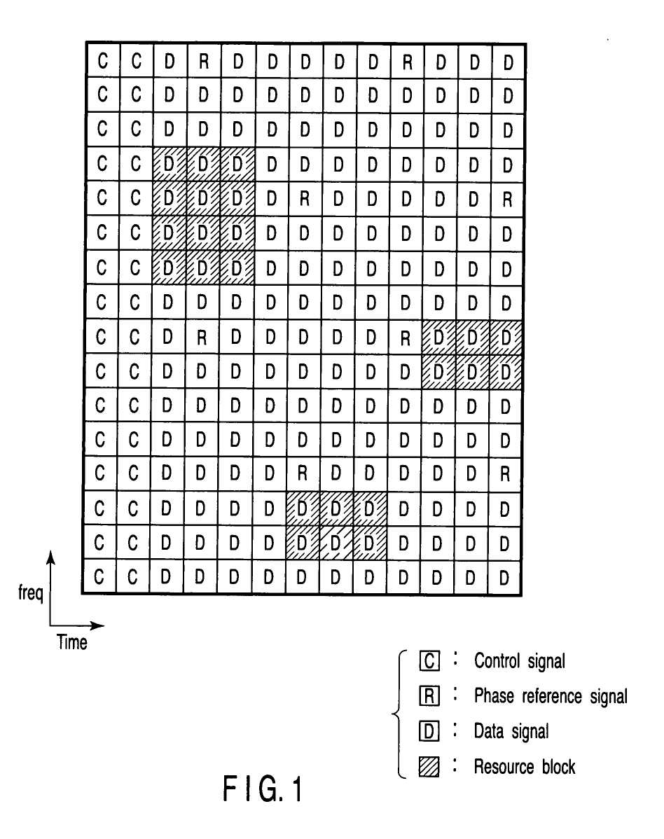

A reference signal (hereinafter called a phase reference signal) used for the CQI measurement on the mobile station side is allocated by one symbol in each certain frequency band as shown in FIG. 1, and transmitted from the base station. For this reason, deterioration of the CQI accuracy is worried. A control information channel (hereinafter called a control signal) is allocated to the entire system band in a certain cycle.

For example, if the CQI transmitted from the mobile station to the base station is higher as compared with the actual propagation environment, the transmission rate is too high and reception of the individual information channel may be failed in the transmission format directed by the base station. If the CQI transmitted from the mobile station to the base station is higher as compared with the actual propagation environment, the transmission rate is too low and throughput may be lowered in the transmission format directed by the base station.

Thus, to correct the error in the CQI, outer loop control using a receive error rate of the individual information channel or the like is executed in the present invention. In other words, the CQI is corrected on the basis of the receive error rate of the individual information channel or the like in a certain band and the transmission format is determined on the basis of the corrected CQI. The receive error rate is discriminated from a result of checking an error code added to the individual information channel, for example, a CRC (Cyclic Redundancy Check) code.

In the following descriptions, OFDM is employed as a modulation scheme of the communications between the base station and the mobile station.

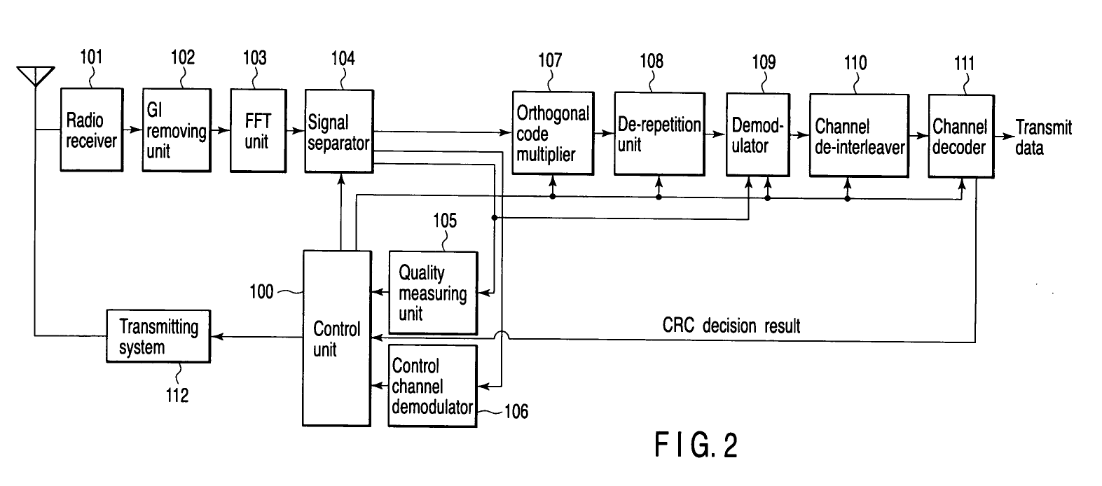

First, a structure of the mobile station in the radio communications system according to the first embodiment of the present invention will be described. FIG. 2 mainly shows a structure of a receiving system of a downstream line provided in the mobile station.

As shown in FIG. 2, the mobile station comprises a control unit 100, a radio receiver 101, a GI (Guard Interval) removing unit 102, an FFT (Fast Fourier Transform) unit 103, a signal separator 104, a quality measuring unit 105, a control channel demodulator 106, an orthogonal code multiplier 107, a de-repetition unit 108, a demodulator 109, a channel de-interleaver 110, a channel decoder 111, and a transmitting system 112.

The radio receiver 101 comprises a bandpass filter which receives a radio signal transmitted from the base station and removes noise outside a desired band from the received signal, and an AD converter which converts the signal passing through the filter into a baseband digital signal.

The GI removing unit 102 removes a guard interval from the baseband digital signal output from the radio receiver 101.

The FFT unit 103 subjects the digital signal from which the guard interval is removed by the GI removing unit 102, to the fast Fourier transform, converts time-domain signals into frequency-domain signals, and thereby divides the digital signal into signals for respective sub-carriers.

The signal separator 104 separates the signals divided for the respective sub-carriers into control signals, phase reference signals, data signals and the like, and outputs the separated signals to modules corresponding thereto. In this embodiment, the phase reference signals are output to the quality measuring unit 105 and the demodulator 109. The control signals are signals allocated to sub-carriers of the control channels, and are output to the control channel demodulator 106. The data signals are signals allocated to sub-carriers of individual information channels, and are output to the orthogonal code multiplier 107.

The quality measuring unit 105 measures a power level or power density of signals received from the respective base stations, by making correlation between scrambling patterns allocated to the respective base stations and the received phase reference signals. Then, the quality measuring unit 105 determines the base station which is to execute radio communications, on the basis of the measurement result, to obtain an interference level from a ratio of the receive power level to receive power levels of the other base stations.

The control channel demodulator 106 demodulates the control signals input from the signal separator 104, extracts control information on a physical layer, and outputs the control information to the control unit 100. The control information includes MCS information indicating transmission formats transmitted from the base stations.

The orthogonal code multiplier 107 cancels signal components from the other base stations in the data signals by multiplying the data signals by a complex conjugate of an orthogonal code corresponding to parameter N directed by the control unit 100, and then outputs the multiplication results. If the parameter N=1, the orthogonal code multiplier 107 outputs the data signal as they are without multiplying the data signals by the complex conjugate of the orthogonal code.

The de-repetition unit 108 accumulates the multiplication results of the orthogonal code multiplier 107, by the parameter N directed by the control unit 100, and outputs the accumulated multiplication results as one data element. If the parameter N=1, the de-repetition unit 108 outputs the multiplication results as they are without accumulating the multiplication results.

The demodulator 109 obtains a channel estimate of a sub-carrier frequency from the phase reference signals, executes channel equivalence of the output of the de-repetition unit 108 by using the channel estimate, demodulates the equivalence result in a demodulation scheme directed by the control unit 100, and thereby regenerates bit strings of the data signals.

The channel de-interleaver 110 subjects the bit strings output from the demodulator 109 to channel de-interleaving, on the basis of an interleaving pattern directed by the control unit 100.

The channel decoder 111 subjects the bit strings output from the channel de-interleaver 110 to channel decoding at a coding rate R directed by the control unit 100, and regenerates transmit data. In addition, the channel decoder 111 executes CRC decision based on CRC bits, for each resource block, at the channel decoding. The control unit 100 is notified of the decision result.

The control unit 100 generates control information including CQI indicating the interference level obtained by the quality measuring unit 105, and transmits the control information to the base stations over the transmitting system 112. Similarly, the control unit 100 generates control information including CRC information indicating the result of the CRC decision on each resource block obtained by the channel decoder 111, and transmits the control information to the base station via the transmitting system 112. The result of the CRC decision on each of the resource block indicates success/failure by binary data (for example, success by “0” and failure by “1”).

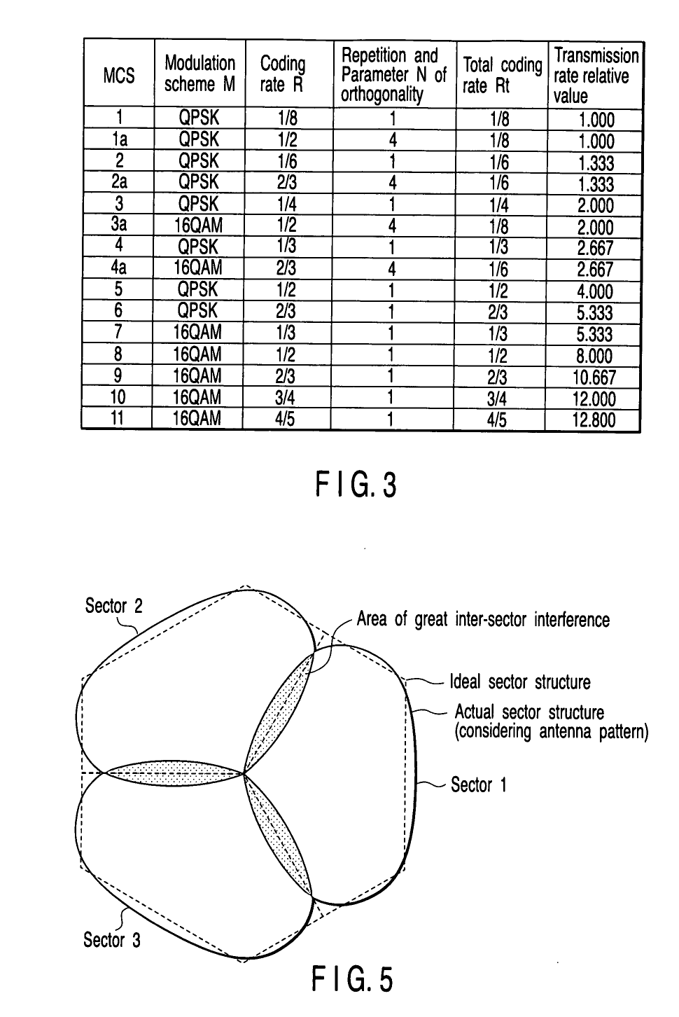

The control unit 100 stores a transmission format table as shown in FIG. 3. In the transmission format table, information elements such as MCS information to distinguish the transmission format, modulation scheme M, coding rate R, parameter N to determine the number of repetitions and the orthogonality and the like are associated with one another.

The control unit 100 detects the MCS information from the control information extracted by the control channel demodulator 106, and recognizes that the transmission format which the base station uses for the transmission to the own mobile station is the transmission format indicated by the MCS information. Then, the control unit 100 controls all the units of the mobile station with the parameter corresponding to the MCS information, so as to receive the information transmitted from the base station with reference to the transmission format table. The control unit 100 thereby receives the signals transmitted in the transmission format from the base station.

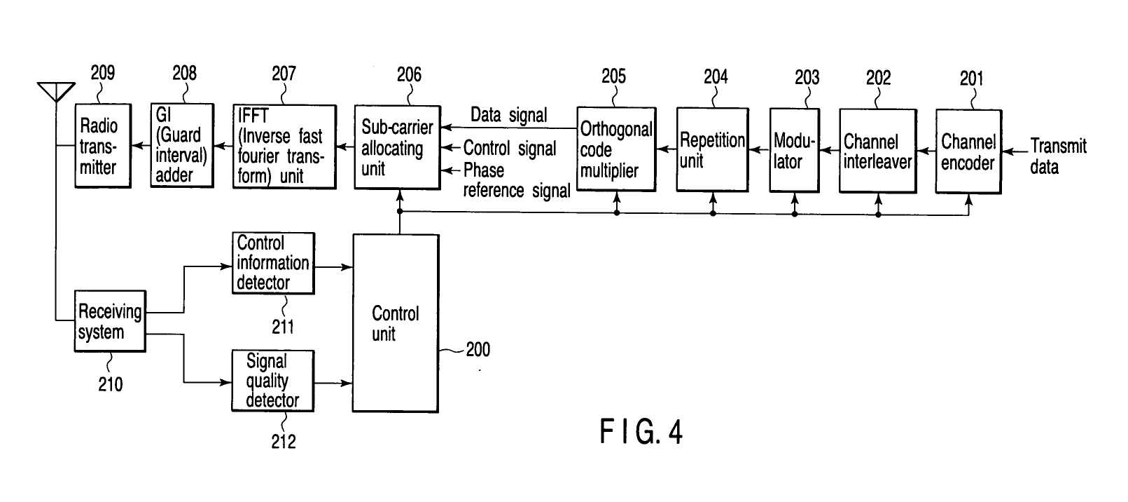

Next, a structure of the base station in the radio communications system according to the first embodiment of the present invention will be described. FIG. 4 mainly shows a structure of the transmitting system of a downstream line provided in the base station. The base station is accommodated in the mobile communications network to repeat the mobile station and the mobile communications network. In the following descriptions, constituent elements on communications with the mobile communications network are omitted.

As shown in FIG. 4, the base station comprises a control unit 200, a channel encoder 201, a channel interleaver 202, a modulator 203, a repetition unit 204, an orthogonal code multiplier 205, a sub-carrier allocating unit 206, an IFFT (Inverse Fast Fourier Transform) unit 207, a GI (Guard Interval) adder 208, a radio transmitter 209, a receiving system 210, a control information detector 211 and a signal quality detector 212.

The channel encoder 201 subjects the bit strings in the transmit data to the channel encoding, at a coding rate R directed by the control unit 200.

The channel interleaver 202 subjects an output of the channel encoder 201 to channel interleaving, on the bases of the interleaving pattern directed by the control unit 200.

The modulator 203 modulates an output of the channel interleaver 202 in modulation scheme M directed by the control unit 200, and then generates a data signal represented as a complex value.

The repetition unit 204 subjects the data signal to a repetition process, on the basis of the parameter N directed by the control unit 200, and extends each of bits included in the data signal into N bit. If N=1 is directed, the repetition unit 204 does not execute the repetition.

The orthogonal code multiplier 205 multiplies an output of the repetition unit 204 by an orthogonal code of an N-bit length, on the basis of the parameter N directed by the control unit 200. If N=1 is directed, the multiplication is not executed.

The sub-carrier allocating unit 206 generates signals by allocating the data signal output from the orthogonal code multiplier 205, the control signal and the phase reference signal to respectively corresponding sub-carriers, on the basis of a direction from the control unit 200.

The IFFT unit 207 subjects the signals output from the sub-carrier allocating unit 206 to OFDM modulation and thereby generates OFDM signals as a plurality of OFDM symbol sequences. In other words, the IFFT unit 207 generates the OFDM signal by converting the frequency-area signals into time-area signals.

The GI adder 208 adds a guard interval to the OFDM signal output from the IFFT unit 207 and then outputs the OFDM signals.

The radio transmitter 209 comprises a digital-analog converter which subjects the output of the GI adder 208 to digital-analog conversion, an up-converter which up-converts an output of the digital-analog converter, and a power amplifier which amplifies an output of the up-converter. A radio (RF) signal is thereby generated and transmitted from the antenna.

The receiving system 210 receives the radio signal transmitted from the mobile station.

The control information detector 211 detects the control information which is to be transmitted to the base station, in the signal which the receiving system 210 has received from the mobile station. The control information often includes the CQI and the CRC decision.

The signal quality detector 212 detects the quality of the signal which the receiving system 210 has received from the mobile station.

The control unit 200 stores the transmission format table as shown in FIG. 3. Then, the control unit 200 selects the transmission format which is to be used for the transmission to the mobile station, on the basis of the control information (CQI) detected by the control information detector 211 and the signal quality detected by the signal quality detector 212. After that, the control unit 200 reselects the selected transmission format, by considering the control information (result of the CRC decision on each resource block) detected by the control information detector 211. The control unit 200 adds the MCS information indicating the reselected transmission format to the control information and transmits the control information to the mobile station.

The transmission format prestored in the control unit 200 is composed of a combination of the modulation scheme M, the coding rate R, and the parameter N to determine the number of repetitions and the orthogonality, and the coding rate R and distribution to the repetition number N are varied. The reference to the selection of the transmission format is to discriminate whether the location of the mobile station is in an area which can be influenced by the interference, between sectors formed by base stations as shown in, for example, FIG. 5, on the basis of the control information (CQI and the result of CRC decision) and the signal quality, and to determine the transmission format in accordance with the discrimination result. The determination method will be described later.

When the transmission format is determined, the control unit 200 transmits the MCS information indicating the determined transmission format to the mobile station. After that, the control unit 200 controls all the units of the mobile station so as to allow the data signal to be transmitted to the mobile station in the transmission format.

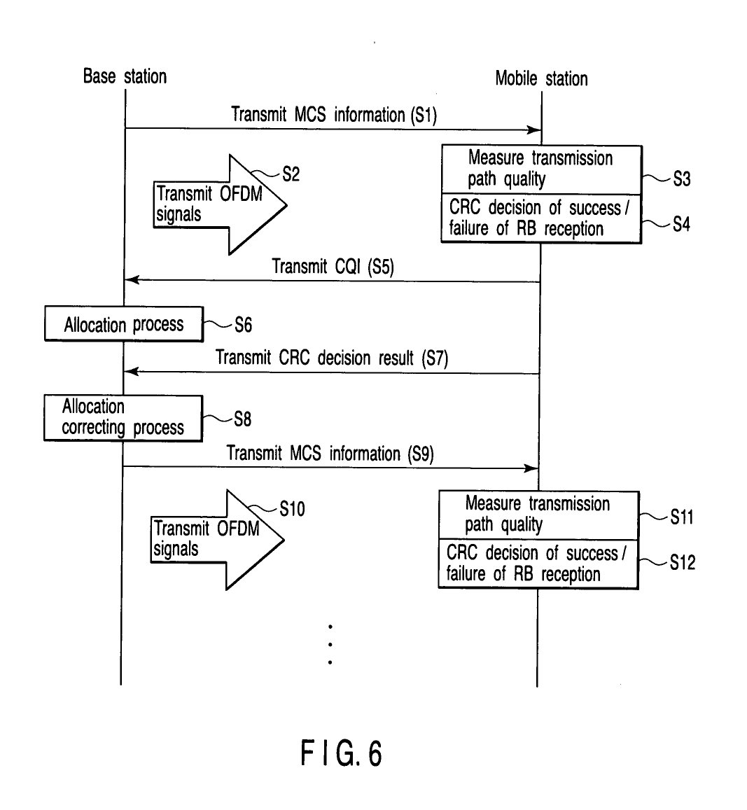

Next, operations of the radio communications system having the above-described structure will be described. FIG. 6 shows sequences of allocating the resource blocks to the mobile station. The operations of allocation will be described with reference to FIG. 6. The sequences are repeatedly executed while communications between the base station and the mobile station are executed.

First, in sequence S1, the control unit 200 of the base station selects the transmission format on the basis of the CQI which the base station has received from the mobile station, determines the resource blocks which are to be allocated to the mobile station by considering the CQI and, for example, the amount of information which is to be transmitted, transmission power which is to be allocated, previous band allocation and the like, includes the MCS information indicating the selected transmission format and the allocation information designating the resource blocks to the control information, and transmits the control information to the mobile station. The control unit 200 stores the identification information of the mobile station and the MCS information in association with each other.

In sequence S2, the control unit 200 of the base station controls all the units to transmit the OFDM signals to the mobile station. In other words, the control unit 200 transmits signals of the transmission format selected in the sequence S1, through the resource blocks allocated in the sequence S1. The data signals, control signals and the phase reference signals are thereby transmitted from the base station to the mobile station. At this time, the base station transmits the phase reference signals, for example, at the density shown in FIG. 1, through the resource blocks which are not allocated to the mobile station.

On the other hand, in sequence S3, the control unit 100 of the mobile station controls all the units to receive the control information transmitted from the base station in the sequence S1, and receive the OFDM signals transmitted from the base station on the basis of the control information. In other words, the control unit 100 receives the resource blocks indicating the allocation information included in the control information, in the transmission format indicated by the MCS information. The quality measuring unit 105 measures the interference level of the received signals.

In sequence S4, similarly to the sequence S3, the control unit 100 of the mobile station controls all the units to receive the resource blocks allocated to the mobile station on the basis of the allocation information and the MCS information, and the channel decoder 111 executes the CRC decision of each of the resource blocks, by using CRC bits, at the channel decoding. Success/failure of the reception through each of the resource blocks allocated to the mobile station is thereby discriminated.

In sequence S5, the control unit 100 of the mobile station generates the control information including the CQI indicating the interference level which has been measured in the sequence S3, and transmits the control information to the base station via the transmitting system 112.

In sequence S6, the control unit 200 of the base station controls all the units to receive the CQI which has been transmitted from the mobile station in the sequence S5, and the signal quality detector 212 detects the receive quality of the signal received from the mobile station. On the basis of these, the control unit 200 selects the transmission format for the transmission to the mobile station, from the transmission format table shown in FIG. 3, and executes the allocation process for determining which resource blocks should be allocated, by considering the CQI and, for example, the amount of information which is to be transmitted, transmission power which is to be allocated, previous band allocation and the like.

In sequence S7, the control unit 100 of the mobile station controls all the units to generate the control information including a result of the CRC decision of each of the resource blocks which has been executed in the sequence S4, and transmits the control information to the base station via the transmitting system 112.

In sequence S8, the control unit 200 of the base station receives the result of the CRC decision on each of the resource blocks transmitted from the mobile station in the sequence S5. The control unit 200 executes an allocation correcting process for obtaining a rate of success S in the reception of the resource blocks on the basis of the result of the CRC decision, and reselecting the transmission format selected by the allocation process in the sequence S6 on the basis of the rate of success S.

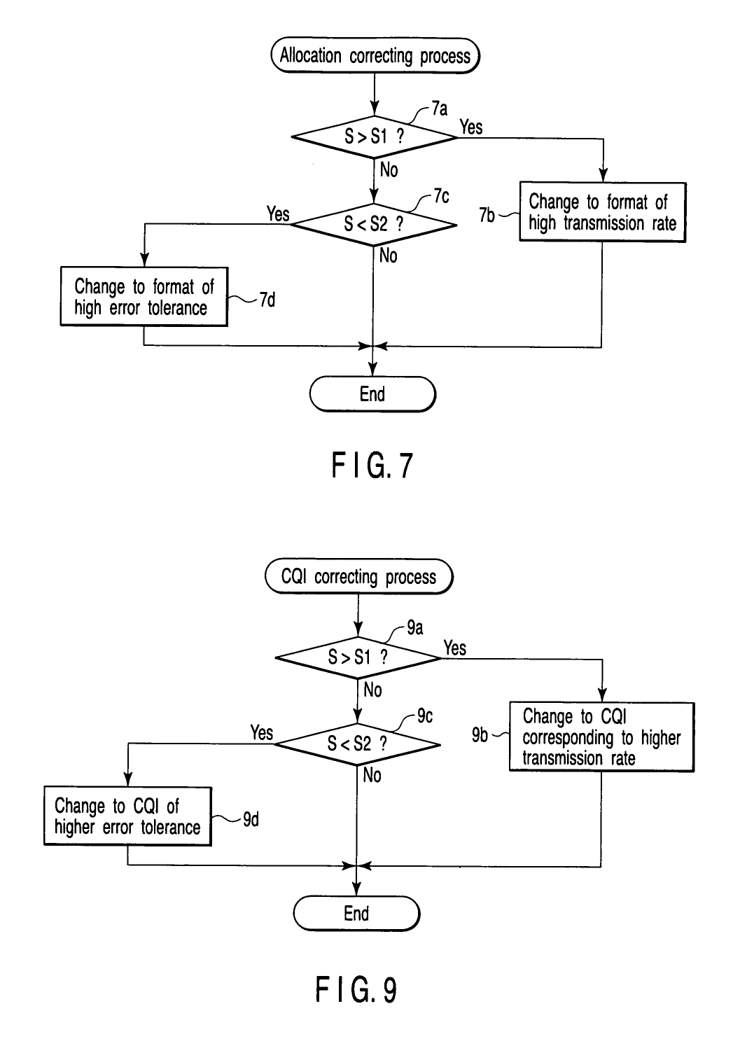

The allocation correcting process is executed with reference to a flowchart shown in, for example, FIG. 7. In step 7a, the control unit 200 discriminates whether or not the rate of success S in the reception is greater than preset threshold value S1. If the rate of success S in the reception is greater than the preset threshold value S1, the control unit 200 shifts to step 7b. If the rate of success S in the reception is equal to or smaller than the preset threshold value S1, the control unit 200 shifts to step 7c.

In step 7b, the control unit 200 reselects in the transmission format table a transmission format having a higher transmission rate by one step than the transmission format corresponding to the MCS information which has been stored in the sequence S1, and ends this process.

In step 7c, the control unit 200 discriminates whether or not the rate of success S in the reception is smaller than preset threshold value S2 (<S1). If the rate of success S in the reception is smaller than the preset threshold value S2, the control unit 200 shifts to step 7d. If the rate of success S in the reception is equal to or higher than the preset threshold value S2, the control unit 200 ends this process.

In step 7d, the control unit 200 reselects in the transmission format table a transmission format having a higher error tolerance by one step than the transmission format corresponding to the MCS information which has been stored in the sequence S1, and ends this process.

In sequence S9, the control unit 200 of the base station adds the MCS information indicating the transmission format reselected in the sequence S8 (if not reselected, the transmission format selected in the sequence S6) and the allocation information to designate the resource blocks determined in the sequence S6, to the control information, and transmits the control information to the mobile station. The control unit 200 stores the identification information of the mobile station and the MCS information in association with each other.

In sequence S10, the control unit 200 of the base station controls all the units to transmit the OFDM signals to the mobile station. In other words, signals of the transmission format selected in the sequence S9 are transmitted via the resource blocks allocated in the sequence S9. The data signals, the control signals and the phase reference signals are thereby transmitted from the base station to the mobile station.

After sequences S11 and S12, the base station repeats the same process as that in the sequences S3 to S10, and executes the transmission to the mobile station in the transmission format corresponding to the rate of success S in receiving the resource blocks.

As described above, the base station determines the transmission format by considering not only the CQI of which the mobile station notifies the base station, but also the rate of success S in receiving the resource blocks.

Therefore, adaptive control of high accuracy to select the transmission format which exactly reflects the channel characteristic, can be executed in the radio communications system having the above-described configuration.

Next, a radio communications system according to a second embodiment of the present invention will be described. A mobile station of the radio communications system according to the second embodiment is different in control of the control unit 100 alone from the mobile station of the first embodiment shown in FIG. 2, and has seemingly the same configuration as the mobile station of the first embodiment. In addition, a base station of the second embodiment is different in control of the control unit 200 alone from the mobile station of the first embodiment shown in FIG. 4, and has seemingly the same configuration as the mobile station of the first embodiment. Thus, the differences of the second embodiment from the first embodiment are mainly described with reference to these figures.

The control unit 100 generates the CQI indicating the interference level which the quality measuring unit 105 has obtained, and corrects the generated CQI on the basis of the result of the CRC decision in each of the resource blocks which the channel decoder 111 has obtained. The control unit 100 generates the control information including the corrected CQI and transmits the generated control information to the base station via the transmitting system 112. In addition, the control unit 100 stores the transmission format table corresponding to the CQI, in the transmission format table shown in FIG. 3.

The control unit 200 stores the transmission format table shown in FIG. 3. On the basis of the control information (CQI) detected by the control information detector 211 and the signal quality detected by the signal quality detector 212, the control unit 200 selects the transmission format which is to be used for the transmission to the mobile station, includes the MCS information indicating the selected transmission format in the control information and transmits the control information to the mobile station.

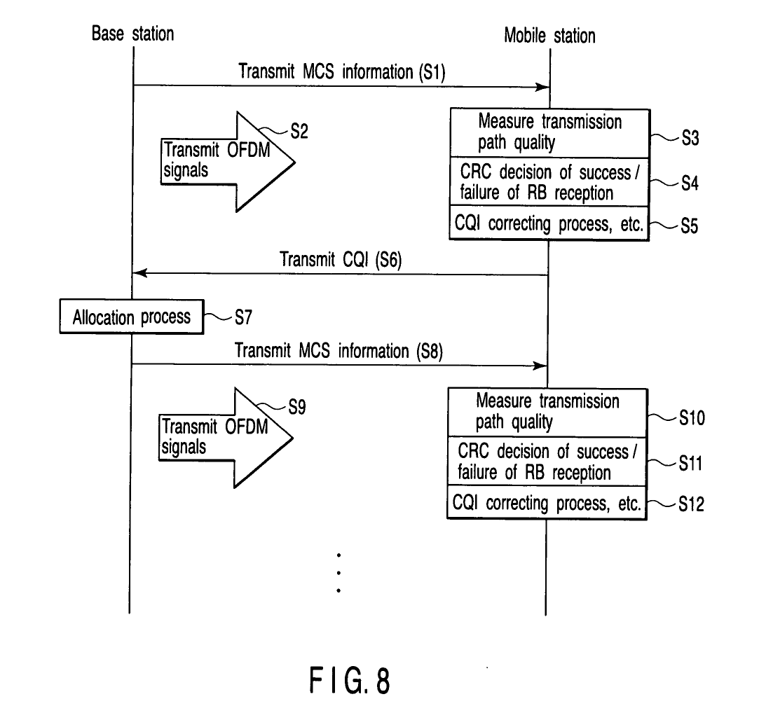

Next, operations of the radio communications system according to the second embodiment will be described. FIG. 8 shows sequences of allocating the resource blocks to the mobile station. The operations will be described with reference to FIG. 8. The sequences are repeatedly executed while the communications between the base station and the mobile station are executed.

First, in sequence S1, the control unit 200 of the base station selects the transmission format on the basis of the CQI which the base station has received from the mobile station, determines the resource blocks which are to be allocated to the mobile station by considering the CQI and, for example, the amount of information which is to be transmitted, transmission power which is to be allocated, previous band allocation and the like, includes the MCS information indicating the selected transmission format and the allocation information designating the resource blocks to the control information, and transmits the control information to the mobile station.

In sequence S2, the control unit 200 of the base station controls all the units to transmit the OFDM signals to the mobile station. In other words, the control unit 200 transmits signals of the transmission format selected in the sequence S1, through the resource blocks allocated in the sequence S1. The data signals, control signals and the phase reference signals are thereby transmitted from the base station to the mobile station. At this time, the base station transmits the phase reference signals, for example, at the density shown in FIG. 1, through the resource blocks which are not allocated to the mobile station.

On the other hand, in sequence S3, the control unit 100 of the mobile station controls all the units to receive the control information transmitted from the base station in the sequence S1, and receive the OFDM signals transmitted from the base station on the basis of the control information. In other words, the control unit 100 receives the resource blocks indicating the allocation information included in the control information, in the transmission format indicated by the MCS information. The quality measuring unit 105 measures the interference level of the received signals.

In sequence S4, similarly to the sequence S3, the control unit 100 of the mobile station controls all the units to receive the resource blocks allocated to the mobile station on the basis of the allocation information and the MCS information, and the channel decoder 111 executes the CRC decision of each of the resource blocks, by using CRC bits, at the channel decoding. Success/failure of the reception through each of the resource blocks allocated to the mobile station is thereby discriminated.

In sequence S5, the control unit 100 of the mobile station generates the CQI indicating the interference level which has been measured in the sequence S3, and obtains rate of success S in receiving the resource blocks on the basis of the result of the CRC decision. The control unit 100 executes a CQI correcting process for correcting the CQI on the basis of the rate S.

The CQI correcting process is executed with reference to a flowchart shown in, for example, FIG. 9. In step 9a, the control unit 100 discriminates whether or not the rate of success S in the reception is greater than preset threshold value S1. If the rate of success S in the reception is greater than the preset threshold value S1, the control unit 100 shifts to step 9b. If the rate of success S in the reception is equal to or smaller than the preset threshold value S1, the control unit 100 shifts to step 9c.

In step 9b, the control unit 100 selects the CQI corresponding to the transmission format of a higher transmission rate than that of the transmission format corresponding to the CQI obtained in the sequence S5, by referring to the CQI-corresponding transmission format table, and ends this process.

In step 9c, the control unit 100 discriminates whether or not the rate of success S in the reception is smaller than preset threshold value S2 (<S1). If the rate of success S in the reception is smaller than the preset threshold value S2, the control unit 100 shifts to step 9d. If the rate of success S in the reception is equal to or higher than the preset threshold value S2, the control unit 100 ends this process.

In step 9d, the control unit 100 selects the CQI corresponding to the transmission format of a higher error tolerance than that of the transmission format corresponding to the CQI obtained in the sequence S5, by referring to the CQI-corresponding transmission format table, and ends this process.

In sequence S6, the control unit 100 of the mobile station controls all the units to generate the control information including the CQI selected in the CQI correcting process in the sequence S5 (if not selected in the CQI correcting process, the CQI obtained in the sequence S5) and transmits the control information to the base station via the transmitting system 112.

In sequence S7, the base station receives the CQI transmitted from the mobile station in the sequence S6, and detects the reception quality of the signals which the signal quality detector 212 has received from the mobile station. On the basis of these, the control unit 200 selects the transmission format which is to be used for the transmission to the mobile station, from the transmission format table shown in FIG. 3, and executes an allocating process for determining the resource blocks which are to be allocated to the mobile station by considering the CQI and, for example, the amount of information which is to be transmitted, transmission power which is to be allocated, previous band allocation and the like.

In sequence S8, the control unit 200 of the base station controls all the units to include the MCS information indicating the transmission format selected in the sequence S7 and the allocation information designating the resource blocks, to the control information, and transmit the control information to the mobile station.

In sequence S9, the base station transmits the OFDM signals to the mobile station. In other words, signals of the transmission format selected in the sequence S8 are transmitted via the resource blocks allocated in the sequence S8. The data signals, the control signals and the phase reference signals are thereby transmitted from the base station to the mobile station.

After sequences S10, S11 and S12, the base station repeats the same process as that in the sequences S3 to S9, and executes the transmission to the mobile station in the transmission format corresponding to the rate of success S in receiving the resource blocks.

As described above, the mobile station does not transmit the obtained CQI as it is, but corrects the CQI by considering the rate of success S in receiving the resource blocks. The transmission format corresponding to the rate of success S is determined on the base station side.

Therefore, adaptive control of high accuracy to select the transmission format which exactly reflects the channel characteristic, can be executed in the radio communications system having the above-described configuration.

Next, a radio communications system according to a third embodiment of the present invention will be described. A mobile station of the radio communications system according to the third embodiment is different in control of the control unit 100 and the channel decoder 111 alone from the mobile station of the first embodiment shown in FIG. 2, and has seemingly the same configuration as the mobile station of the first embodiment. In addition, a base station of the third embodiment is different in control of the control unit 200 alone from the mobile station of the first embodiment shown in FIG. 4, and has seemingly the same configuration as the mobile station of the first embodiment. Thus, the differences of the second embodiment from the first embodiment are mainly described with reference to these figures.

The channel decoder 111 executes the CRC decision on the control signals and notifies the control unit 100 of a result of the CRC decision. The control unit 100 generates the control information including the CQI indicating the interference level which the quality measuring unit 105 has obtained, and transmits the control information to the base station via the transmitting system 112. The control unit 100 also generates the control information including the CRC information indicating a result of the CRC decision on the control signals obtained by the channel decoder 111, and transmits the control information to the base station via the transmitting system 112. The result of the CRC decision on each of the control signals represents success/failure by binary data (for example, success by “0” and failure by “1”).

The control unit 200 stores the transmission format table shown in FIG. 3. On the basis of the control information (CQI) detected by the control information detector 211 and the signal quality detected by the signal quality detector 212, the control unit 200 selects the transmission format which is to be used for the transmission to the mobile station. After that, the control unit 200 reselects the selected transmission format by considering the control information detected by the control information detector 211 (result of the CRC decision on each of the control signals). The control unit 200 includes the MCS information indicating the reselected transmission format in the control information and transmits the control information to the mobile station.

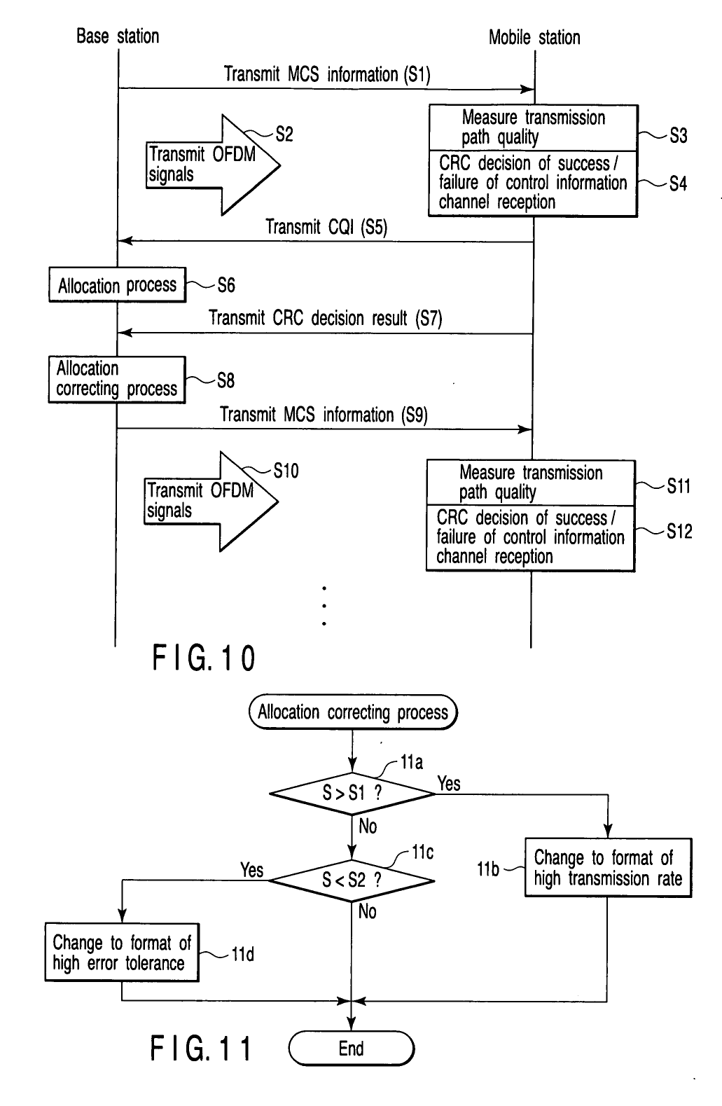

Next, operations of the radio communications system according to the third embodiment will be described. FIG. 10 shows sequences of allocating the resource blocks to the mobile station. The operations will be described with reference to FIG. 10. The sequences are repeatedly executed while communications between the base station and the mobile station are executed.

First, in sequence S1, the control unit 200 of the base station selects the transmission format on the basis of the CQI which the base station has received from the mobile station, determines the resource blocks which are to be allocated to the mobile station by considering the CQI and, for example, the amount of information which is to be transmitted, transmission power which is to be allocated, previous band allocation and the like, includes the MCS information indicating the selected transmission format and the allocation information designating the resource blocks to the control information, and transmits the control information to the mobile station. The control unit 200 stores the identification information of the mobile station and the MCS information in association with each other.

In sequence S2, the control unit 200 of the base station controls all the units to transmit the OFDM signals to the mobile station. In other words, the control unit 200 transmits signals of the transmission format selected in the sequence S1, through the resource blocks allocated in the sequence S1. The data signals, control signals and the phase reference signals are thereby transmitted from the base station to the mobile station. At this time, the base station transmits the phase reference signals, for example, at the density shown in FIG. 1, through the resource blocks which are not allocated to the mobile station.

On the other hand, in sequence S3, the control unit 100 of the mobile station controls all the units to receive the control information transmitted from the base station in the sequence S1, and receive the OFDM signals transmitted from the base station on the basis of the control information. In other words, the control unit 100 receives the resource blocks indicating the allocation information included in the control information, in the transmission format indicated by the MCS information. The quality measuring unit 105 measures the interference level of the received signals.

In sequence S4, the control unit 100 of the mobile station controls all the units to receive the control signals in the band of the resource blocks allocated to the mobile station on the basis of the allocation information and the MCS information, and the channel decoder 111 executes the CRC decision of the control signals, by using CRC bits, at the channel decoding. Success/failure of receiving the control signals in the band of the resource blocks allocated to the mobile station is thereby discriminated.

In sequence S5, the control unit 100 of the mobile station generates the control information including the CQI indicating the interference level which has been measured in the sequence S3, and transmits the control information to the base station via the transmitting system 112.

In sequence S6, the control unit 200 of the base station controls all the units to receive the CQI which has been transmitted from the mobile station in the sequence S5, and the signal quality detector 212 detects the receive quality of the signal received from the mobile station. On the basis of these, the control unit 200 selects the transmission format for the transmission to the mobile station, from the transmission format table shown in FIG. 3, and executes the allocation process for determining which resource blocks should be allocated, by considering the CQI and, for example, the amount of information which is to be transmitted, transmission power which is to be allocated, previous band allocation and the like.

In sequence S7, the control unit 100 of the mobile station controls all the units to generate the control information including a result of the CRC decision of the control signals which has been executed in the sequence S4, and transmits the control information to the base station via the transmitting system 112.

In sequence S8, the control unit 200 of the base station receives the result of the CRC decision on the control signals transmitted from the mobile station in the sequence 5. The control unit 200 executes an allocation correcting process for obtaining a rate of success S in the reception of the control signals on the basis of the result of the CRC decision, and reselecting the transmission format selected by the allocation process in the sequence S6 on the basis of the rate of success S.

The allocation correcting process is executed with reference to a flowchart shown in, for example, FIG. 11. In step 11a, the control unit 200 discriminates whether or not the rate of success S in the reception is greater than preset threshold value S1. If the rate of success S in the reception is greater than the preset threshold value S1, the control unit 200 shifts to step 11b. If the rate of success S in the reception is equal to or smaller than the preset threshold value S1, the control unit 200 shifts to step 11c.

In step 11b, the control unit 200 reselects in the transmission format table a transmission format having a higher transmission rate by one step than the transmission format corresponding to the MCS information which has been stored in the sequence S1, and ends this process.

In step 11c, the control unit 200 discriminates whether or not the rate of success S in the reception is smaller than preset threshold value S2 (<S1). If the rate of success S in the reception is smaller than the preset threshold value S2, the control unit 200 shifts to step 11d. If the rate of success S in the reception is equal to or higher than the preset threshold value S2, the control unit 200 ends this process.

In step 11d, the control unit 200 reselects in the transmission format table a transmission format having a higher error tolerance by one step than the transmission format corresponding to the MCS information which has been stored in the sequence S1, and ends this process.

In sequence S9, the control unit 200 of the base station adds the MCS information indicating the transmission format reselected in the sequence S8 (if not reselected, the transmission format selected in the sequence S6) and the allocation information to designate the resource blocks determined in the sequence S6, to the control information, and transmits the control information to the mobile station. The control unit 200 stores the identification information of the mobile station and the MCS information in association with each other.

In sequence S10, the control unit 200 of the base station controls all the units to transmit the OFDM signals to the mobile station. In other words, signals of the transmission format selected in the sequence S9 are transmitted via the resource blocks allocated in the sequence S9. The data signals, the control signals and the phase reference signals are thereby transmitted from the base station to the mobile station.

After sequences S11 and S12, the base station repeats the same process as that in the sequences S3 to S10, and executes the transmission to the mobile station in the transmission format corresponding to the rate of success S in receiving the control signals.

As described above, the base station determines the transmission format by considering not only the CQI of which the mobile station notifies the base station, but also the rate of success S in receiving the control signals.

Therefore, adaptive control of high accuracy to select the transmission format which exactly reflects the channel characteristic, can be executed in the radio communications system having the above-described configuration.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above-described embodiments, the rate of success S in the reception obtained from the result of the CRC decision is compared with the threshold values S1 and S2 and, in accordance with a result of the comparison, the transmission format is changed or the CQI is corrected. Instead of this, however, when the rates of success S of a plurality of samples are above the threshold value S1 or below the threshold value S2 not in one comparison, but in successive comparisons, the transmission format may be changed or the CQI may be corrected.

It is thus considered that the resource blocks allocated to the mobile station, i.e. the frequency band allocated thereto may be changed until the rates of success S of a plurality of samples are obtained. However, even if the allocated frequency band is changed, the control unit 100 and the control unit 200 handle the rates of success S as the same rates and discriminate the necessity of changing the transmission format or correcting and the CQI.

According to this, the present invention can be applied to a case where the transmission format or the CQI does not need to be corrected, such as a case where the rates of success S in the reception are fluctuated temporarily. When the necessity of changing the transmission format or correcting the CQI is thus discriminated on the basis of the rates of success S of a plurality of samples, the broadband channel characteristic can be reflected on selection of the transmission format since the band to which the resource blocks are allocated may be changed.

In addition, the rates of success S in a broadband may be obtained positively. In other words, even if the rates of success S in the same broadband are obtained, the control unit 100 and the control unit 200 may handle them as one single rate of success S, collect rates of success S in a different band, and discriminate the necessity of changing the transmission format and correcting the CQI on the basis of the rates of success in the broadband.

In the above-described embodiments, the mobile station executes the CRC decision of the band of the resource blocks allocated to the own mobile station. However, the control unit 100 may execute the CRC decision of the band which is not allocated and, on the basis of the CRC decision, the control unit 100 and the control unit 200 may change the transmission format or correct the CQI. It is thereby possible to recognize the receiving status of the broadband and reflect the broadband channel characteristic on selection of the transmission format.

Moreover, the base station executing the control described in the first or third embodiment and a conventional base station that does not execute such control may exist together in a system. In this case, it is possible to discriminate whether or not the base station executes such control by executing the following test steps.

The resource blocks of the system band are separated into ten resource blocks RB[0] to RB[9]. The mobile station which executes a test for the base station always returns intentionally the highest value as the CQI of the RB[0], for example, and then the lowest value as the other resource blocks.

In response to the mobile station, the base station discriminates RB[0] as an appropriate resource by receiving the highest CQI of RB[0 ] returned from the mobile station, and allocates RB[0] to the mobile station as the resource block. Actually, however, as the RB[0] is not the resource block in which the highest CQI can be obtained or the mobile station cannot receive the CQI in the transmission format corresponding to the highest CQI, the mobile station returns a response indicating failure as the result of the CRC decision. If this is continued, the transmission rate of the transmission format allocated to the mobile station is set to be gradually lower in the base station of the present invention, as the response indicating the failure as the result of the CRC decision is continuously returned no matter which resource block is allocated under the outer loop control of the present invention.

Thus, after confirming that the transmission format is set to be lower than the transmission format corresponding to the CQI, the mobile station returns the highest CQI of RB[9], for example, and also returns the lowest value of the other resource blocks. At this time, the base station allocates RB[9] to the mobile station. If the transmission format of this resource block is a transmission format of a low transmission rate that does not match the highest CQI, the base station is understood to have the above algorithm. In other words, the base station of the present invention can be identified by returning the CQI in the above-described manner.

In the first and third embodiments, the control unit 200 of the base station generates the MCS information on the basis of the CQI transmitted from the mobile station and corrects the MCS information with the result of the CRC decision. Initially, however, the control unit 200 may generate the MCS information on the basis of the CQI and the result of the CRC decision.

In the second embodiment, the control unit 100 of the mobile station measures the transmission path quality, generates the CQI on the basis of the measured transmission path quality, and corrects the generated CQI with the result of the CRC decision. Initially, however, the control unit 100 may generate the CQI on the basis of the transmission path quality and the result of the CRC decision.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communications system comprising a base station accommodated in a mobile communications network and a mobile station which establishes radio communications with the base station,
the mobile station comprising:
a measuring unit which receives a radio signal transmitted from the base station and measures a transmission path quality;
a decision unit which executes error decision of data received from the base station; and
a transmitter which transmits information based on a measurement result of the measuring unit and information based on a decision result of the decision unit,
the base station comprising:
a receiver which receives the information transmitted from the transmitter; and
a determiner which determines a transmission format of the data to be transmitted to the mobile station, with reference to the information based on the measurement result of the measuring unit and the information based on the decision result of the decision unit.

2. The system according to claim 1, wherein the determiner comprises a first determiner which determines the transmission format of the data to be transmitted to the mobile station, with reference to the information based on the measurement result of the measuring unit, and a second determiner which changes the transmission format determined by the first determiner, with reference to the information based on the decision result of the decision unit.

3. The system according to claim 1, wherein the decision unit executes the error decision of the data transmitted from the base station to the mobile station.

4. The system according to claim 1, wherein the decision unit executes the error decision of the data transmitted from the base station in a plurality of communications bands.

5. A mobile radio terminal establishing radio communications with a base station accommodated in a mobile communications network, comprising:
a measuring unit which receives a radio signal transmitted from the base station and measures a transmission path quality;
a decision unit which executes error decision of data received from the base station;
a generator which generates information indicating the transmission path quality with the base station, with reference to a measurement result of the measuring unit and a decision result of the decision unit; and
a transmitter which transmits the information generated by the generator, to the base station.

6. The mobile radio terminal according to claim 5, wherein the generator comprises a first generator which generates the information indicating the transmission path quality with the base station, with reference to information based on the measurement result of the measuring unit, and a second generator which corrects the information generated by the first generator, with reference to information based on the decision result of the decision unit.

7. A method of radio communications in a radio communications system comprising a base station accommodated in a mobile communications network and a mobile station which establishes radio communications with the base station, the method comprising:
receiving a radio signal transmitted from the base station and measuring a transmission path quality, by the mobile station;
executing error decision of data received from the base station, by the mobile station;
transmitting information based on a measurement result of the measuring step and information based on a decision result of the decision step, by the mobile station;
receiving the transmitted information, by the base station; and
determining a transmission format of the data to be transmitted to the mobile station, by the base station, with reference to the information based on the measurement result of the measuring step and the information based on the decision result of the decision step.

8. The method according to claim 7, wherein the determining step comprises a first determining step of determining the transmission format of the data to be transmitted to the mobile station, with reference to the information based on the measurement result of the measuring step, and a second determining step of changing the transmission format determined in the first determining step, with reference to the information based on the decision result of the decision step.

9. The method according to claim 7, wherein the decision step executes the error decision of the data transmitted from the base station to the mobile station.

10. The system according to claim 7, wherein the decision step executes the error decision of the data transmitted from the base station in a plurality of communications bands.

11. A method of radio communications in a mobile radio terminal establishing radio communications with a base station accommodated in a mobile communications network, the method comprising:
receiving a radio signal transmitted from the base station and measuring a transmission path quality;
executing error decision of data received from the base station;
generating information indicating the transmission path quality with the base station, with reference to a measurement result of the measuring step and a decision result of the decision step; and
transmitting the information generated in the generating step, to the base station.

12. The method according to claim 11, wherein the generating step comprises a first generating step of generating the information indicating the transmission path quality with the base station, with reference to information based on the measurement result of the measuring step, and a second generating step of correcting the information generated in the first generating step, with reference to information based on the decision result of the decision step.
